(19) United States
(12) Patent Application Publication
(10) Pub. No.: US 2010/0277746 A1
(43) Pub. Date: Nov. 4, 2010

(54) METHOD AND SYSTEM FOR LATERAL SCANNING INTERFEROMETRY

(75) Inventors: Liang-Chia Chen, Taipei County (TW); Yi-Shaun Lin, Keelung City (TW); Yi-Wei Chang, Yilan County (TW)

Correspondence Address: WPAT, PC;INTELLECTUAL PROPERTY ATTORNEYS, 7225 BEVERLY ST., ANNANDALE, VA, 22003, US

(73) Assignee: NATIONAL TAIPEI UNIVERSITY OF TECHNOLOGY, Taipei (TW)

(21) Appl. No.: 12/771,171

(22) Filed: Apr. 30, 2010

(30) Foreign Application Priority Data
Apr. 30, 2009 (TW) 098114331

(51) Int. Cl. G01B 9/02

(52) U.S. Cl. 356/519

(57) ABSTRACT

The present invention provides method and system for lateral scanning interferometry (LSI), which utilizes a reflecting reference element having a tilted angle for generating a tilted optical plane formed by wavefronts of a reference light so that interferometric patterns are acquired according to interferometric lights directed through an objective lens or an array of micro objective lens for analysis while the surface parts of the object enters the coherent range formed by the wavefronts of the reference light during lateral movement and a maximum signal intensity with respect to the acquired interferometric patterns can be obtained while the surface profile of the object has a zero or near zero optical path difference (OPD) with respect to the plane of wavefronts. The present invention is capable of reducing time cost comparing to the conventional vertical scanning interferometric method while enabling the system to be utilized for in-line (in-situ) measurement.

### FIELD OF THE INVENTION

The present invention is related to an interferometry, and, more particularly, is related to a method and system for lateral scanning interferometry for reconstructing surface profile with respect to an object according to interferometric patterns obtained by interfering object light and inclined reference light during lateral scanning operation.

### BACKGROUND OF THE INVENTION

Since the optical or optical-electronic inspection method has high precision and contactless characteristics, it is common for inspecting the profile, thickness or size of a tiny object. With the development of the optical technology, currently, various kinds of optical and contactless inspection technology such as confocal microscopy, phase shifting interferometry, and vertical scanning white-light interferometry, are widely utilized, wherein each kind of inspection technology is capable of being adapted for specific inspection condition and inspection application field.

In the conventional vertical scanning white-light interferometry, a clear and sharp interferometric pattern is formed when a zero or near-zero optical path difference between a reference light, reflected from the reflecting reference element disposed inside the optical objective, and an object light, reflected from an object, is occurred. After that, the vertical scanning process is performed for obtaining a series of interferometric images, respectively, corresponding to a different scanning depth. Following this, a computing device is utilized to process the series of interferometric images for obtaining three-dimensional information of the object and to reconstruct the surface profile of the object. According to the foregoing method, white-light interferometric system acquiring three-dimensional information with respect to the surface profile of the object by the vertical scanning process still has the following significant problems to be improved for in-situ automatic optical inspection (AOI). The first problem is that since the vertical scanning is necessary for obtaining the series of interferometric images with respect to a specific location on the object in the conventional white-light interferometric system, the inspection efficiency is poor due to the long scanning time so that it is difficult to be applied in the in-line real-time inspection. The second problem is that the vertical scanning process is easily affected and interfered by the vibration in the in-line (in-situ) inspection environment, thereby reducing the inspection accuracy.

Meanwhile, conventional art such as U.S. Pat. No. 6,449,048 provides a lateral-scanning interferometer with a tilted optical axis for achieving lateral scanning. In the art, a tilted interferometer with a lateral scanning process replaces the conventional vertical scanning process for measuring the surface profile of the object. Please refer to FIG. 1, the interferometer consists of a light source 10, collimating lens 11, beam splitter 12, reflecting reference element 13 and image acquiring device 14. Since the white-light interferometer usually adopts an optical objective having high magnification such that the objective is near to the surface of the object, i.e. the working distance between the objective and the object is usually small. When the object is moved laterally, the surface of the object may easily interfere with the objective, thereby making the method infeasible for practical operation during the lateral scanning process.

In order to consider the distance between the object and the objective, there has limitation for choosing the magnification of the objective in the conventional white-light interferometric system. In addition, even if the way of tilting the whole interferometric system can achieve the purpose of lateral scanning, there still has a problem with respect to the height limit of the object. In other words, the height of the object has limitation for preventing the objective of the interferometric system from interfering with the tested object. Nevertheless, even if the working distance between the object and objective can be overcome by increasing the working distance, not only is the numerical aperture (N/A) of the objective reduced and cost of the objective expensive, but also a negative effect with respect to the object's surface having a high contour slope or curvature may be also seriously encountered.

Besides, the U.S. Pat. No. 7,330,574 discloses a method for evaluation the optimum focal distance during the lateral scanning process, which improves the objective on the basis of the interferometric system of U.S. Pat. No. 6,449,048, wherein the objective has a micro lens array formed by a plurality of micro elements for establishing an optimum focal plane intersecting the surface of the object. Since the interferometric system has a tilted angle, the distance between each micro element and the surface of the object is different from each other. Thus, it is capable of identifying optimum focal distance with respect to each position on the surface of the object by tracing the focal quality during the lateral scanning. However, since the interferometric system has a tilted angle, likewise, its problem is still the same as the one occurred in U.S. Pat. No. 6,449,048.

### SUMMARY OF THE INVENTION

The present invention provides a method and system for lateral scanning interferometry which tilts a reflecting reference element at an angle such that optical plane formed by wavefronts of a reference light is tilted so that the lateral scanning can be utilized to replace the conventional vertical scanning for obtaining the cross-section profile information of the object, and thereby the time cost of the conventional vertical scanning system can be minimized to improve the efficiency of the interferometry.

In an exemplary embodiment, the present invention provides a method for lateral scanning interferometry comprising steps of: providing a lateral scanning interferometric system comprising a light source for providing an inspection light, an interference lens module having a reflecting reference element and a beam splitter for splitting the inspection light into a first inspection light being projected onto an object thereby forming an object light and a second inspection light being projected onto the reflecting reference element thereby forming a reference light, wherein the reference light further meets and interferes with the object light at the beam splitter so as to form an interfering light, and an image sensing module for acquiring the interfering light; inclining the reflecting reference element at a preset tilted angle with respect to the optical axis; and performing a lateral scanning by the lateral scanning interferometric system and acquiring the interfering light for forming an interferometric image by the image sensing module.

In another exemplary embodiment, the present invention further provides a lateral scanning interferometric system comprising: a light source for providing a inspection light; an interference lens module including a reflecting reference element having a preset tilted angle with respect to an optical axis and a beam splitter for splitting the inspection light into a first inspection light being projected onto an object thereby forming an object light and a second inspection light being projected onto the reflecting reference element thereby forming a reference light, wherein the reference light interferes with the object light so as to form an interfering light; an image sensing module acquiring the interfering light for forming an interferometric image; and a moving stage for supporting the object and performing a lateral movement.

In another exemplary embodiment, the present invention further provides a lateral scanning interferometric system comprising a lateral scanning interferometric system comprising: a light module for providing at least one inspection light; an interference lens module having at least one reflecting reference element respectively having a preset tilted angle with respect to an optical axis, at least one micro-objective module, each of which including a plurality of micro-objective lens, each of the micro-objective lens having a focal depth so that the plurality of micro-objective lens forms a continuous interferometric coherent plane having the tilted angle with respect to the optical axis, and at least one beam splitter, each beam splitter splitting the inspection light into a first inspection light being projected onto an object thereby forming an object light and a second inspection light being projected onto the reflecting reference element thereby forming a reference light, wherein the reference light interferes with the object light so as to form at least one interfering light; an image sensing module having a plurality of image sensing elements for receiving the at least one interfering light, thereby forming at least one interferometric image; and a moving stage for supporting the object and performing a lateral movement.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 illustrates a lateral-scanning interferometer with a tilted optical axis.

FIG. 2 illustrates a lateral interferometric system according to the present invention.

FIGS. 3A and 3B illustrate a first embodiment of interference lens module according to the present invention.

FIG. 3C illustrates another embodiment of the lateral scanning interferometric system according to the present invention.

FIG. 3D illustrates another embodiment of micro-objective module according to the present invention.

FIG. 3E illustrates another embodiment of image sensing module according to the present invention.

FIG. 4A illustrates the relation between the surface of the object and the coherent range.

FIG. 4B illustrates relation between a row of sensing elements of the image sensing module and corresponding image acquired along a specific direction of the interferometric image.

FIG. 4C illustrates an interferometric image acquired by the interference lens module according to the present invention.

FIG. 5A illustrates a third embodiment of the interference lens module according to the present invention.

FIG. 5B illustrates a fourth embodiment of the interference lens module according to the present invention.

FIG. 5C illustrates a perspective view of the micro objective unit according to the present invention.

FIG. 5D illustrates a two dimensional arrangement of the micro-objective module illustrated in FIG. 5B.

FIG. 6A illustrates a fifth embodiment of the interferometric lens according to the present invention.

FIG. 6B illustrates a sixth embodiment of the interferometric lens according to the present invention.

FIG. 6C illustrates a two dimensional arrangement of the micro-objective module illustrated in FIG. 6B.

FIG. 7A depicts a flow chart of a method for lateral scanning interferometry according to the present invention.

FIG. 7B depicts a flow chart of a method for measuring three-dimensional surface profile according to the present invention.

FIG. 8 illustrates the variation of optical path difference with respect to a lateral moving object.

FIG. 9A illustrates a three-dimensional profile of the calibrated reflecting reference element.

FIG. 9B illustrates a cross-sectional view of the calibrated reflecting reference element.

FIG. 10 illustrates interferometric signals with respect to a specific row of the interferometric image.

FIG. 11A illustrates records of interferometric intensity in a memory unit.

FIG. 11B illustrates a reconstructed surface profile of the object according to height information.

FIG. 12 illustrates a perspective view of the step-height block.

FIG. 13A to FIG. 13D illustrates a series of interferometric images acquired by the lateral scanning interferometric system according to the present invention.

FIG. 14A and FIG. 14B, respectively, illustrates a perspective view of surface profile and cross-sectional view with respect to the object shown in FIG. 12 once the reconstruction process is completed.

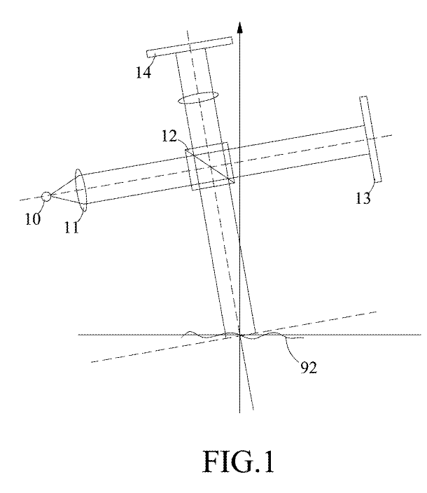

### DETAILED DESCRIPTION OF THE INVENTION

For your esteemed members of reviewing committee to further understand and recognize the fulfilled functions and structural characteristics of the disclosure, several exemplary embodiments cooperating with detailed description are presented as follows.

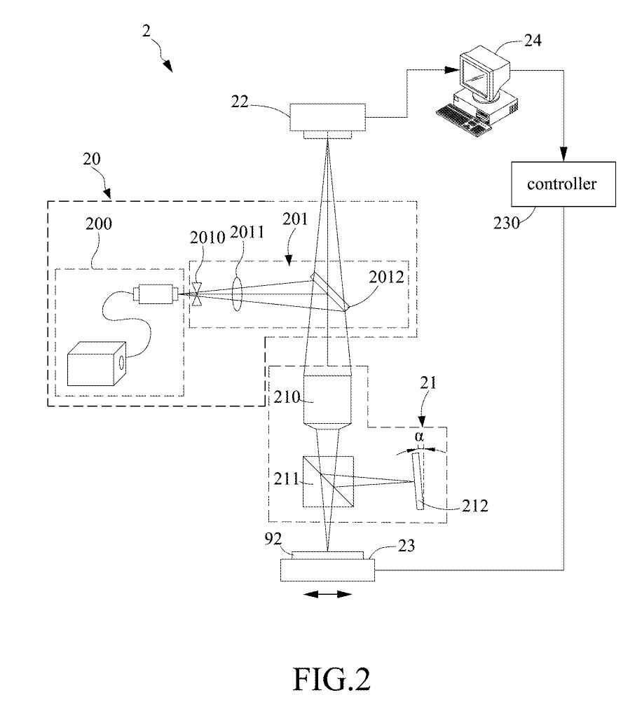

Please refer to FIG. 2, which illustrates a lateral interferometric system according to the present invention. In the present embodiment, the lateral interferometric system comprises a light module 20, an interference lens module 21, an image sensing module 22, a moving stage 23 and a processor 24. The light module 20 has a light source 200 for providing an emitted light and a micro lens module. The emitted light emitted from the light source 200 can be a broad-band light, also called low-coherent light or polychromatic light.

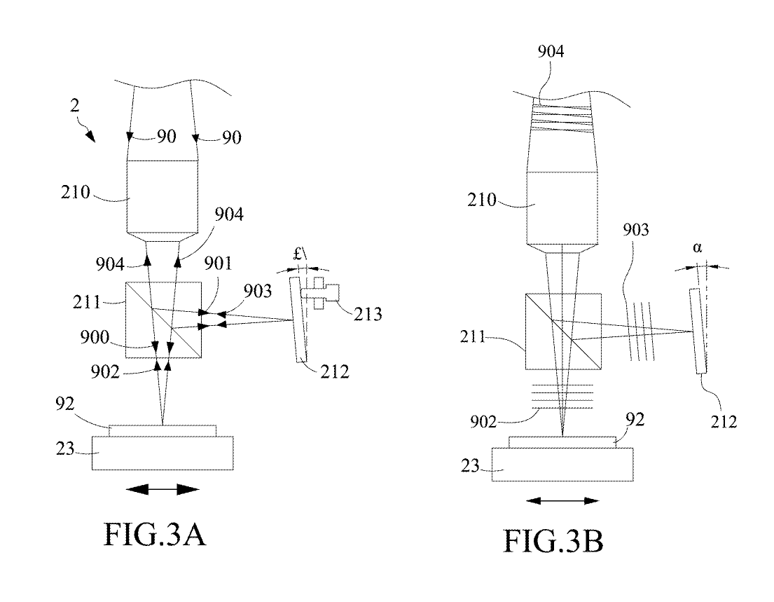

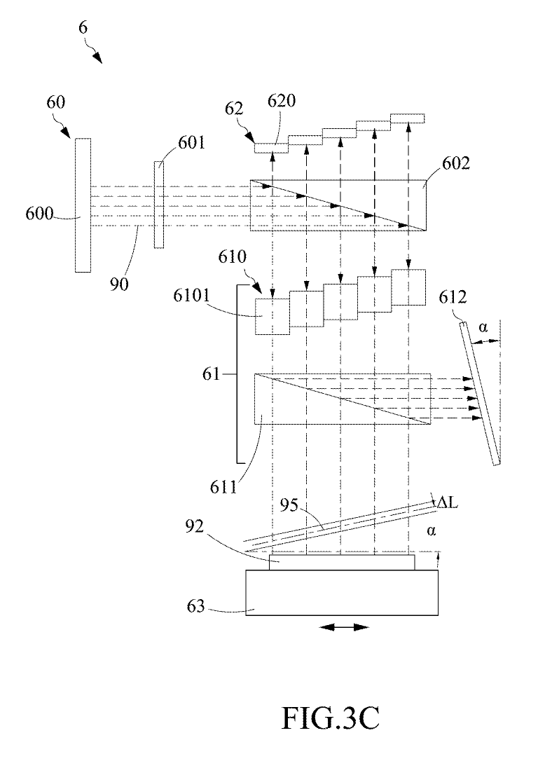

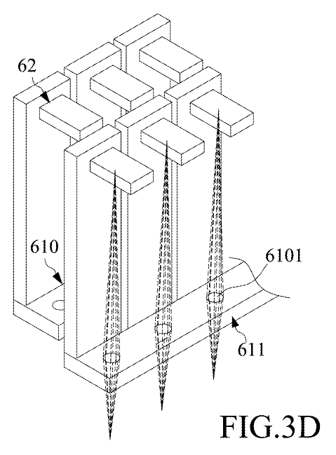

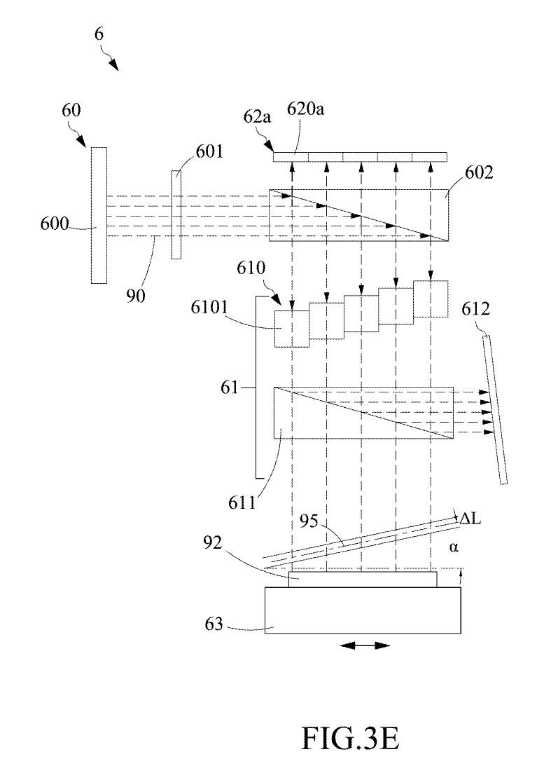

The micro lens module 201 is disposed at a side of the light source 200 for modulating the emitted light into an inspection light. In the present embodiment, the micro lens module 201 has a spatial filter 2010, an optical lens 2011, and a beam splitter 2012. The spatial filter 2010 modulates the light source 200 into a point light source and the optical lens 2011 controls the optical path of the inspection light. It will be appreciated that the spatial filter 2010 and optical lens 2011 are known in the art so that the functions and effects will not be described in detail herein. The beam splitter 2012 reflects the inspection light into the interference lens module 21. Please refer to FIG. 3A, which illustrates a first embodiment of the interference lens module according to the present invention. In the present embodiment, the interference lens module 21 is a modified Michelson interference objective being designed according to the interferometric system shown in FIG. 2. The interference lens module 21 includes a lens unit 210, a beam splitter 211 and a reflecting reference element 212. The lens unit 210 can be, but should not be limited to, an objective which directs inspection light 90 being generated from the light module 20 into the beam splitter 211 and is arranged above an object 23 disposed on the moving stage 23. The beam splitter 211 is arranged on the optical path of the inspection light 90 for dividing the inspection light 90 into a first inspection light 900 and a second inspection light 901. The first inspection light 900 is projected onto the object 92 so as to for an object light 902.

Meanwhile, the reflecting reference element 212 has a tilted angle α with respect to the optical axis for reflecting the second inspection light 901 so that a reference light 903 can be formed for further interfering with the object light 902 at the beam splitter 211 thereby forming an interfering light 904. The tilted angle α defined between the reflecting reference element 212 and a vertical plane is capable of being adjusted for increasing the scanning range. It is noted that the height range of the object capable of being measured during the lateral scanning is adjusted or determined according to the tilted angle of the reflecting reference element 212 and pixel numbers along the lateral scanning direction in the image sensing module 22, such as CCD. In addition, an angle-adjusting unit 213 is coupled to the reflecting reference element 212 for controlling the tilted angle of the reflecting reference element 212. The angle-adjusting unit 213 is capable of being implemented by a known art such as an adjusting screw, wedge mechanism, or a rotatable platform coupled to the reflecting reference element 212. Please refer to FIG. 3B, the wavefronts of the reference light 903 also have a tilted angle when the reflecting reference element 212 is inclined. It will be appreciated that the degree of the tilted angle is determined according to the need for the measuring range and analysis resolution. Back to FIG. 2, the image sensing module 22 receives the interfering light so as to form an interferometric image. In the present embodiment, the image sensing module 22 is a charge-coupled device (CCD), a complementary metal-oxide-semiconductor (CMOS) or any other suitable imaging unit. The moving stage 23 supporting the object 92 is capable of performing at least a two dimensional movement along X-axis direction and Y-axis direction. The processor 24 analyzes the interferometric images for reconstructing the three-dimensional surface profile of the object. In addition, the processor 24 further coupled to a controller 230 of the moving stage 23 for providing a control signal to the controller 230 such that the moving stage 23 is controlled by the controller 230 to perform a lateral movement.

In another embodiment shown in FIG. 3C, which illustrates another lateral scanning interferometric system according to the present invention. The interferometric system has a plurality of micro objectives for increasing depth of field. The interferometric system comprises a light module 60, an interference lens module 61, an image sensing module 62 and a moving stage 63. The light module 60 can provide a plurality of inspection lights and has a light generating element 600, a collimating lens 601, and a beam splitter 602. The light generating element 600 can be a light distribution unit having a digital micro lens array, such as a digital light projector (DLP) or a liquid crystal on silicon (LCOS), for providing the plurality of inspection lights 90 which are the broad-band light or narrow-band light. The beam splitter 602 directs each inspection light to the interference lens module 61 having a micro-objective module 610, a beam splitter 611 and a reflecting reference element 612 having a tilted angle α. The micro-objective module 610 comprises a plurality of micro objectives 6101, each of which has a focal depth range wherein each focal depth range of each micro objective connects to each other so that a continuous interferometric coherent plane 95 corresponding to the micro-objective module 610 can be formed with the tilted angle α and a coherent range ΔL. The arrangement of each two adjacent micro objectives 6101 in the micro-objective module 610 has a height difference.

The embodiment shown in FIG. 3C represents one-dimensional arrangement of the micro-objective module while, in another embodiment shown in FIG. 3D, it represents a two-dimensional arrangement of the micro-objective module. The micro-objective module 610 in FIG. 3D has a plurality of micro objective arrays 611. Each micro objective array 611 has a plurality of micro objectives 6101 arranged linearly, wherein each of two adjacent micro objectives 6101 has a height difference in between. Back to FIG. 3C, each inspection light 90 is directed by the beam splitter 602 to the micro-objective module 610 thereby passing through the beam splitter 611. The beam splitter 611 splits each inspection light 90 into a first inspection light being projected onto the object 92, thereby forming an object light and a second inspection light being projected onto the reflecting reference element 612 having a tilted angle. The reflecting reference element 612 reflects the second inspection light, thereby forming a reference light. Each reference light interferes with the corresponding the object light so as to form an interfering light.

The image sensing module 62 comprises a plurality of image sensing unit 620 respectively corresponding to each micro objective 6101 of the micro-objective module 610 for receiving the plurality of interfering lights, thereby forming an interferometric image having interferometric patterns. In the present embodiment, the image sensing module 62 is a kind of optical sensing device being utilized in a conventional optical microscopic system, i.e. the distance between the image sensing unit 620 and corresponding micro objective 6101 is the same. In the present embodiment, the distance is 160 mm for example. The moving stage 63 supporting the object 92 performs a lateral movement so that the system 6 is capable of performing a lateral scanning, thereby obtaining the interferometric information for reconstructing the surface profile of the object 92. Please refer to FIG. 3E, which illustrates another embodiment of the image sensing module according to the present invention. In the current embodiment, the image sensing module 62a is a kind of sensing devices being employed in an infinitive compensation optical microscopic system, i.e. each image sensing unit 620a locates on the same horizontal plane so that the distance between each image sensing unit 620a and corresponding micro objective is different from each other.

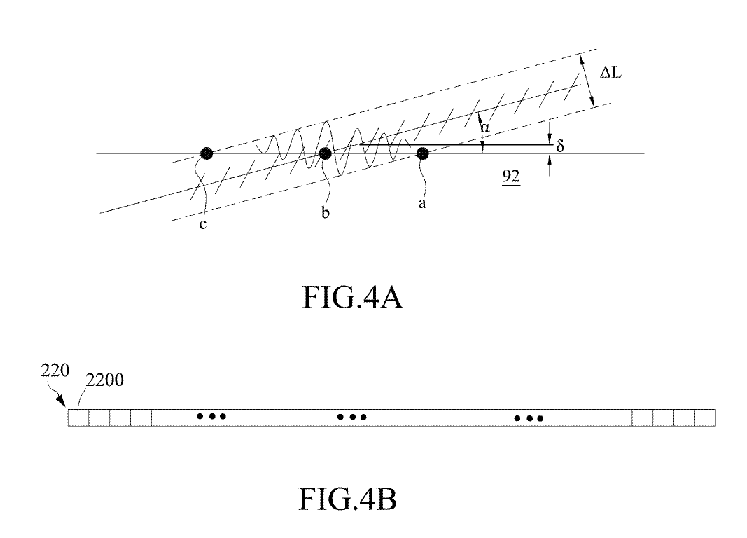

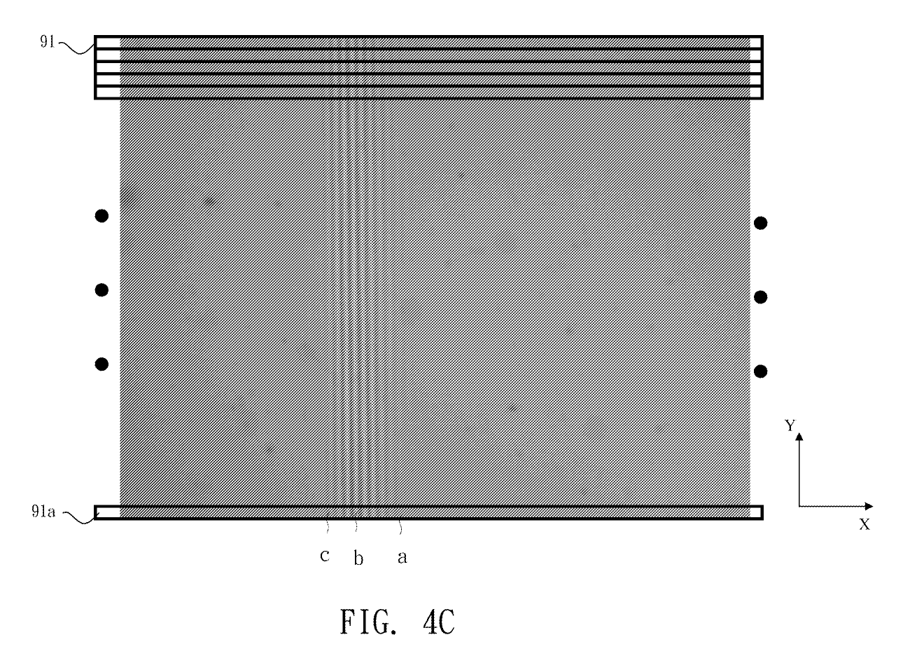

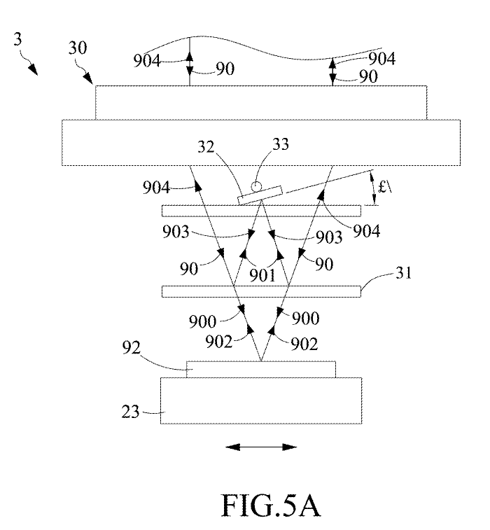

Please refer to FIG. 4A, which illustrates the intensity of the interfering light. Since the reflecting reference element 212 is inclined, there exists a distance δ between each inspection point on the object 92 and a coherent plane formed by the wavefronts of the reference light, i.e. plane having a zero or near zero optical path difference (OPD) between the reference light and object light, wherein the distance δ varies with respect to the tilted angle of the coherence plane. When the reference light interferes with the object light for forming the interfering light, taking an object having the same height as an example, a zero or near zero OPD is occurred between the object light with respect to a specific position on the object and the reference light having the tilted wavefronts so that the interfering light with respect to the zero or near zero optical path difference has the maximum light intensity. In another words, if the distance δ is within the range of the coherent range ΔL, the object light with respect to the inspection point on the object can interfere with the reference light, and the interfering light has the maximum signal intensity when δ is zero, whereas when δ is greater than the light coherent range ΔL, there has no interfering light. Taking the position a, b, and c illustrated in FIG. 4A as an example, position b represents a position having zero or near zero optical path difference between the reference light 903 and object light 902 such that the interfering light with respect to the position b has a maximum signal intensity whereas position a and c has non-zero optical path difference so that interfering lights corresponding to the position a and c are respectively smaller than the intensity associated with location b. Accordingly, as long as the optical path difference gets increasingly larger, the intensity of the interfering light gets increasingly smaller and the object light with respect to the inspection point having an OPD greater than the coherent range ΔL will not interfere with the reference light. The interfering light with respect to each object light and corresponding reference light is sensed by the image sensing module for forming an interferometric image having interferometric patterns. Please refer to FIG. 4C, which illustrates the interferometric image according to the present invention. From the image shown in FIG. 4C, when the object light interferes with the reference light having tilted wavefronts, there is merely an image area with respect to the range defined by position a, b and c showing clear interferometric patterns because the optical path differences associated with range a to c are less than the coherent range ΔL.

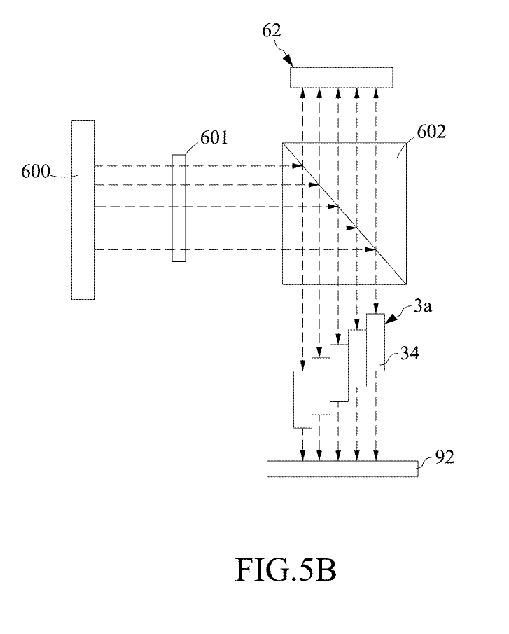

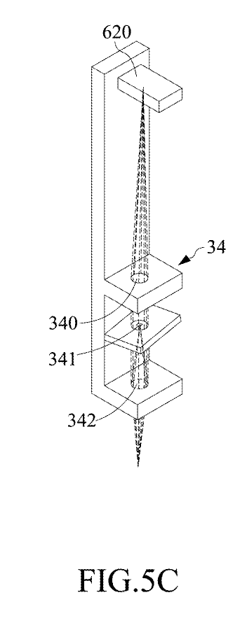

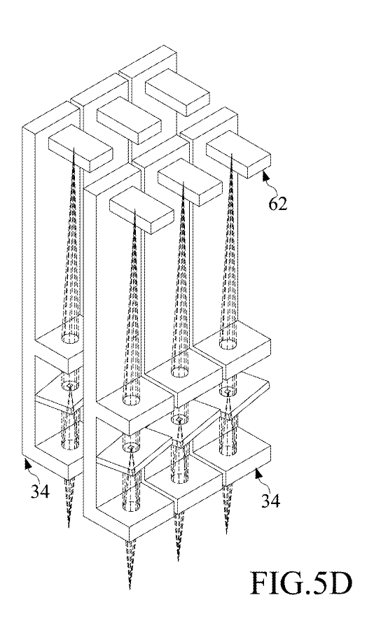

Please refer to FIG. 5A, which illustrates the third embodiment of the interference lens module according to the present invention. In the present embodiment, the interference lens module is a modified Mirau interference lens module 3 comprising a lens unit 30, a beam splitter 31, and a reflecting reference element 32. The lens unit 30 generally can be, but should not be limited to, an objective. The lens unit 30 is capable of directing the inspection light 90 emitted from the light module to be projected onto the object 92 supported by the moving stage 23. The beam splitter 31 disposed on the optical path of the inspection light 90 splits the inspection light 90 into a first inspection light 900 and a second inspection light 901, wherein the first inspection light 900 is projected onto the object 92, thereby forming an object light 902, and the second inspection light 901 is projected onto the reflecting reference element 32 having a tilted angle and being disposed on the top of the beam splitter 31, thereby forming a reference light 903 for interfering with the object light 902 so as to form an interfering light 904. In addition, it is preferred to dispose an angle-adjusting unit 33 coupled to the reflecting reference element 32 for controlling the tilted angle of the reflecting reference element 32.

Please refer to FIG. 5B, which illustrates a fourth embodiment of the interference lens module according to the present invention. The interference lens module shown in FIG. 5B, an alternative design with respect to the interference lens module shown in FIG. 5A, comprises a micro-objective module 3a having a plurality of micro objective unit 34 arranged linearly, wherein each two adjacent micro objective units 34 has a height difference. Each micro objective unit 34 has a focal depth and connects to the focal depth range of the neighbor micro objective unit so that a continuous interferometric coherent plane corresponding to the micro-objective module 3a can be formed with the tilted angle α and the coherent range.

Please refer to FIG. 5C, each micro objective unit 34 has micro objective 340, a reference reflection 341 with a tilted angle 341 and a beam splitter 342. The reference reflection 341 is capable of being adjusted to change the tilted angle by an electrostatic force or by a rotatable means. Although the micro-objective module shown here is a one-dimensional module, alternatively, the micro-objective module shown in FIG. 5D can be a two-dimensional module formed by a plurality of micro objective arrays, wherein each of the two adjacent micro objective arrays has a height difference. As to the image sensing module 62 is similar to the structure shown in FIG. 3C, and it will not be described in details herein.

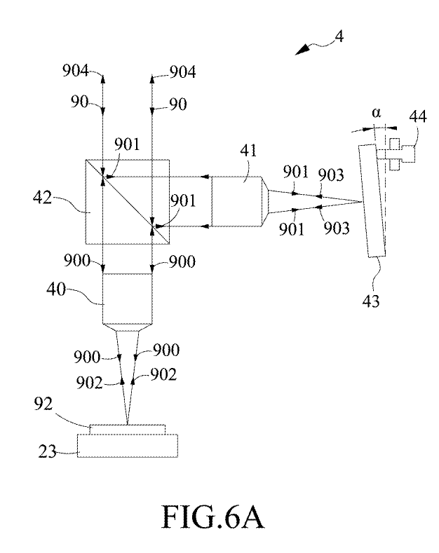

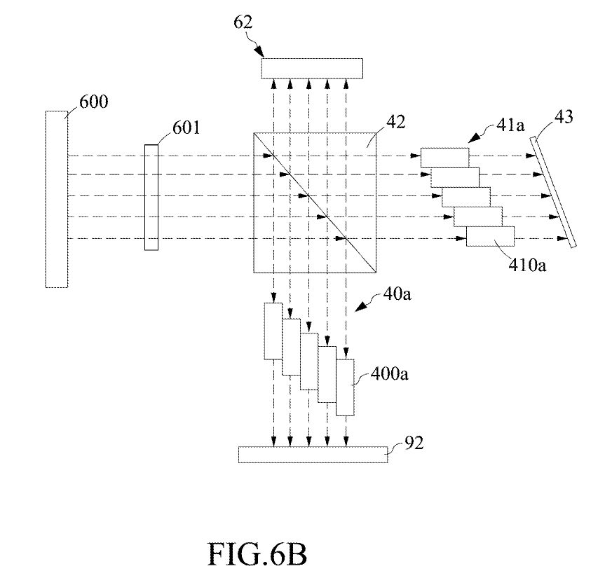

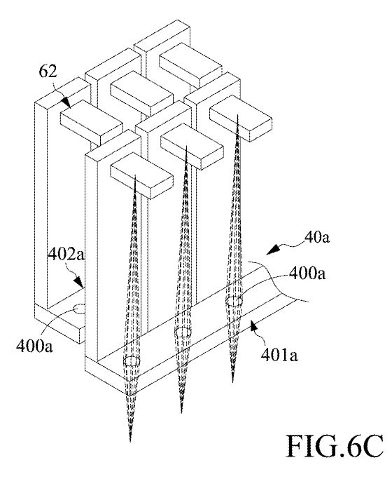

Please refer to FIG. 6A, which illustrates a fifth embodiment of the interference lens module according to the present invention. In the present invention, the interference lens module 4 is a modified Linnik interference lens module, which comprises two lens units 40 and 41, a beam splitter 42, and a reflecting reference element 43. The beam splitter 42 receives the inspection light 90 being emitted from the light module and splits the inspection light 90 into a first inspection light 900 and a second inspection light 901, wherein the first inspection light 900 is projected onto the object 92 by lens unit 40 being disposed above the object 92, thereby forming an object light 902 while the second inspection light 901 passes through another lens unit 41 and then is projected onto the reflecting reference element 43, thereby forming a reference light 903. The reference light 903 interferes with the object light 902 so as to form an interfering light 904. The reflecting reference element 43 further couples to an angle-adjusting unit 44 whereby the tilted angle with respect to the reference reflection unit 43 can be controlled.

Please refer to the FIG. 6B, which illustrates a six embodiment of the interference lens module according to the present invention. The interference lens module shown in FIG. 6B is an alternative design of the interference lens module shown in FIG. 6A, wherein the digital light generating element 600 such as DLP or LCOS is capable of providing a plurality of inspection lights; the two lateral sides of the beam splitter 42 respectively has a micro-objective module 40a and 41a; and, each of the micro-objective module 40a and 41a has a plurality of micro objectives 400a and 410a, respectively for receiving the first inspection light and second inspection split from the beam splitter 42. In the present embodiment, the micro objectives 400a and 410a for each micro-objective module 40a and 41a, respectively, have one-dimensional arrangement, wherein each of the two adjacent micro objectives has a height difference. Alternatively, as shown in FIG. 6C, each of the micro-objective module 40a or 41a has a plurality of one-dimensional micro objective array 401a and 402a to be arranged two-dimensionally, wherein each micro objective array 401a or 402a has a plurality of micro objectives 400a, and a height difference exists between each two adjacent micro objectives.

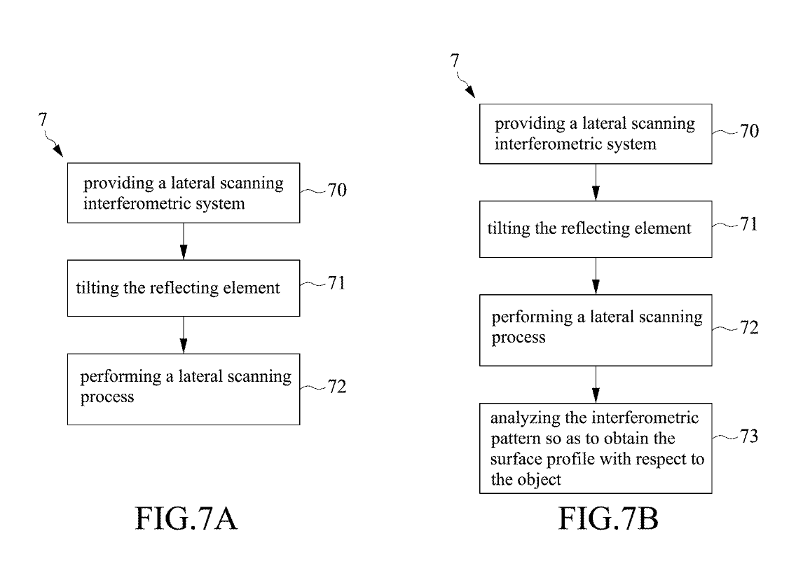

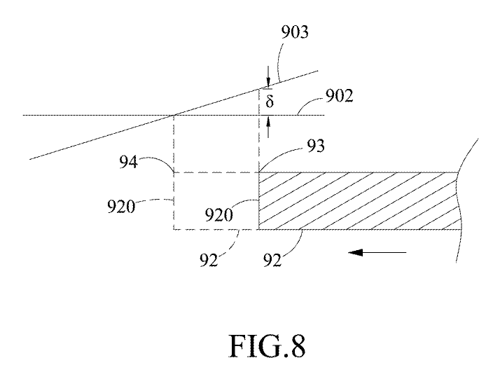

Please refer FIG. 7A, which illustrates an embodiment of method for lateral scanning interferometry according to the present invention. Method 7 is started by a step 70 for providing a lateral scanning interferometric system such as the system shown in FIG. 2. Thereafter, at step 71, the reflecting reference element is tilted at a tilted angle. In the embodiment for step 71, an angle-adjusting unit such as an adjusting screw, wedge mechanism, or a rotatable platform coupled to the reflecting reference element for controlling the tilted angle of the reflecting reference element. After that, at step 72, a lateral scanning process is performed so that the image sensing module can acquire the interfering light for forming interferometric images. It is appreciated that, in the step 72, the lateral scanning process is performed by the controller 230 issuing a control signal for controlling the lateral movement of the moving stage 23 shown in FIG. 2, for example. As illustrated in FIG. 8, since the interfering light formed by interfering the reference light 903 having the tilted wavefronts with the object light 902 may correspond to a specific location 920 on the object 92, the interferometric patterns, associated with the interfering light and formed by the image sensing module, is changed according to the position change of the object on the moving stage 23 performing the lateral movement. Taking the specific position 920 as an example, the optical path difference between the reference light and object light with respect to the specific point 920 may keep varying when the object 92 is moving laterally. For example, in FIG. 8, since the optical path difference, δ, at position 93 is larger than zero, the OPD at position 94, the interferometric pattern with respect to the location 920 on the object 92 at the position 93 is blurred whereas the interferometric pattern with respect to the location 920 on the object 92 at position 94 is well-focused. According to the foregoing described principle, the process for moving the location 920 on the object 92 from position 93 to position 94 by the moving stage 93 is equivalent to the process for moving the interference lens module vertically in the conventional vertical scanning interferometry for obtaining white light interferometric images.

Please refer to FIG. 7B, which depicts a flow chart of a method for measuring three-dimensional surface profiles according to the present invention. The flow is similar to the flow shown in FIG. 7A, but different in that there has a further step 73 for analyzing the interferometric pattern so as to obtain the surface profile with respect to the object. In step 73, the interferometric patterns are processed by calculating the maximum signal intensity of the envelope so as to reconstructing the three-dimensional surface profile of the object.

In the present invention, the reconstruction process is started by performing a calibration of lateral analysis of the interferometric system for obtaining a height relation function corresponding to each sensing element (pixel) in the image sensing module and a linear function with respect to the tilted status of the reflecting reference element before performing the interferometric measurement. Before the calibration, a horizontal level of the moving stage is obtained at first, and the horizontal level is assumed as zero degree in the present embodiment. Please refer to FIG. 2, a standard specimen is disposed on the moving stage 23, and a distance about Z axis is adjusted to a focused position for acquiring the image of the standard specimen. After that, a spatial resolution S_{X} corresponding to each sensing element is calculated by an image process. For conventional white-light interferometry, a Z-axis vertical scanning is necessary for performing height measurement. However, when the surface area of the object is larger than the image acquiring field of the image sensing module, it is necessary to move the object along the X-axis and Y-axis direction in addition to the Z-axis movement so that the whole surface of the object can be measured. Nevertheless, in the present invention, there is no need to perform Z-axis scanning while performing the lateral scanning; therefore, for the same surface area of the object, the efficiency of the lateral scanning is better than that of the conventional white-light vertical scanning interferometry (VSI). In the process of the lateral scanning, the range of depth measurement is related to the tilted angle α and spatial resolution S_{X}, and the relationship is described as equation (1) shown in the following:

Hᵣ=Kₙ·tan α

Kₙ=n·Sₓ (1)

wherein n represents the pixel amount of the CCD along the horizontal direction; Kₙ represents the length of CCD along the horizontal direction; α is the tilted angle; and Hᵣ is range of depth measurement.
According to equation (1), the range of depth measurement is capable of being modulated by adjusting the magnification of the objective, pixel number of the CCD along the scanning direction, and the tilted angle of the reflecting reference element.

Next, the reflecting reference element of interference lens module is calibrated for obtaining the height relation function with respect to each sensing element of the image sensing module, wherein each sensing element corresponds to each pixel of the interferometric image formed by the image sensing module. Taking Michelson interferometer shown in FIG. 3A as an example, the reflecting reference element 212 is inclined at a tilted angle α, and the beam splitter splits the light into two inspection light, wherein one inspection light is projected onto the tilted reflecting reference element 212 and is reflected wherefrom so as to form a reference light while the other inspection light is projected onto the object 92 and reflected wherefrom so as to form an object light. The reference light and the object light are interfered with each other within the beam splitter 211 so as to form an interferometric light having interferometric information. After that, a calibrated flat mirror or an object having a flat surface is disposed on the moving stage 23 for calibrating the reflecting reference element 212. Thereafter, a vertical scanning along Z-axis is performed for obtaining a series of images with respect to the flat mirror. Then an image processing algorithm is applied to the series of images acquired for establishing the linear function of the reflecting reference element so that the tilted angle α can be calculated according to the established linear function.

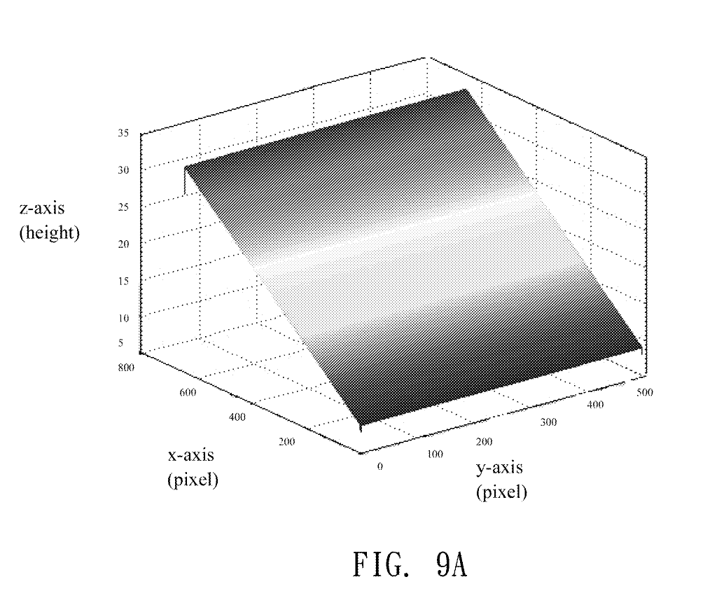

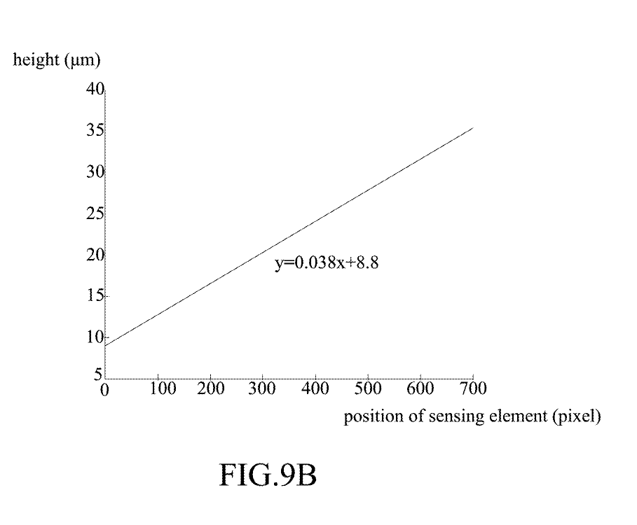

Please refer to FIGS. 9A and 9B, wherein FIG. 9A illustrates a three-dimensional surface profile while FIG. 9B illustrates a cross-sectional view of the reflecting reference element. According to the result shown in FIGS. 9A and 9B, the linear function with respect to the tilted angle of the reflecting reference element can be established and the height corresponding to each pixel can also be calculated in the mean time. Since the foregoing result is established while the horizontal level of the moving stage is of zero degree, if the moving stage has a tilted angle, it is necessary to compensate the linear equation beforehand.

According to the calibrating progress with respect to the reflecting reference element, not only can the tilted status of the reflecting reference element be calculated, but also the depth corresponding to each pixel according to the calibrated linear function can be determined Therefore, when the object is scanned by the lateral scanning process, the surface of the object is scanned through the tilted coherent range formed by the wavefronts of the reference light so as to generate interferometric patterns, wherein a maximum signal intensity with respect to the acquired interferometric patterns can be obtained while the zero or near zero optical path is occurred. After that, the depth with respect to the location having the maximum signal intensity can be determined according to the height relation function corresponding to each pixel in the image. By means of the foregoing method the depth with respect to each location on the surface of the object can be accurately determined, thereby forming a three dimensional surface profile of the object.

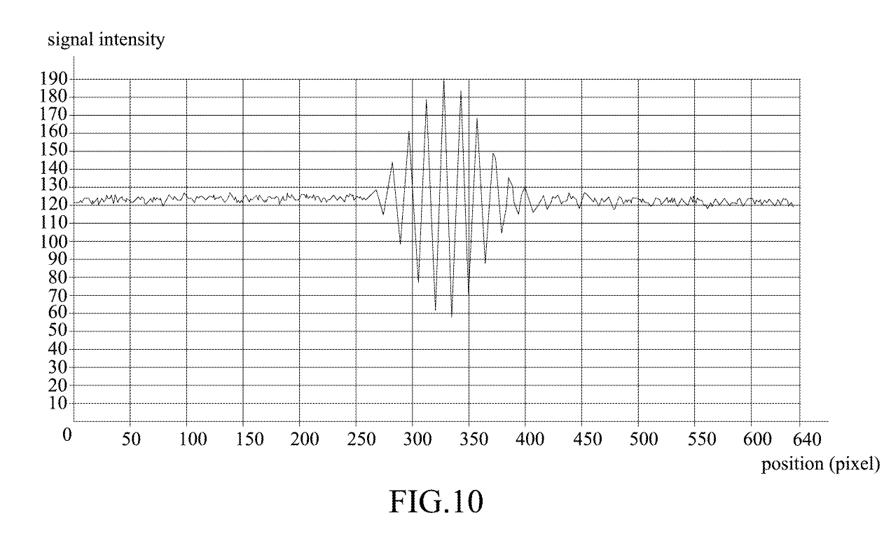

An embodiment of a reconstruction process is described in the below. At first, a plurality of interferometric signals along a first direction of the interferometric image acquired at a specific scanning time is obtained. As illustrated in FIG. 4C, each square area 91 represents an interferometric signal of the acquired interferometric image along the first direction X, i.e. the lateral scanning direction. In FIG. 4B, the size of the square area 91 corresponds to the size of a row of sensing elements 220 in the image sensing module, such as 640×1 pixels, and each element 2200 refers to a pixel. After acquiring a plurality of the square images 91, then each interferometric signal is analyzed so as to obtain a relation between the intensity of the interferometric signal and pixel location illustrated in FIG. 10. Thereafter, the maximum signal intensity of each interferometric signal envelope can be found for determining the location of the sensing element, i.e. a pixel or sub-pixel position corresponding to the location having the maximum signal intensity. For example, if the pixel position of the square area 91 along a second direction Y is located at the 120^{th} pixel, and the location of pixel having its maximum signal intensity is located at 325^{th} pixel according to the chart shown in FIG. 10, accordingly, the position having its maximum signal intensity is at pixel coordinate (325,120). Then, the pixel coordinate value can be substituted into the linear function and height relation function illustrated in FIG. 9A and FIG. 9B so as to obtain and record the corresponding depth, which means that x=325 is substituted into linear function y=0.038*x+8.8 shown in FIG. 9B so that the height corresponding to the x=325 in square area 91 is calculated for obtaining height value y=21.150 nm. The calculation for the other square areas in FIG. 4C is performed for calculating the height value till the last square area 91a and those calculated height values are recorded accordingly. Although foregoing position analysis about the maximum signal intensity is on the basis of pixel analysis, it will be appreciated that, in another embodiment, the position analysis can also be performed by sub-pixel calculation for obtaining better resolution.

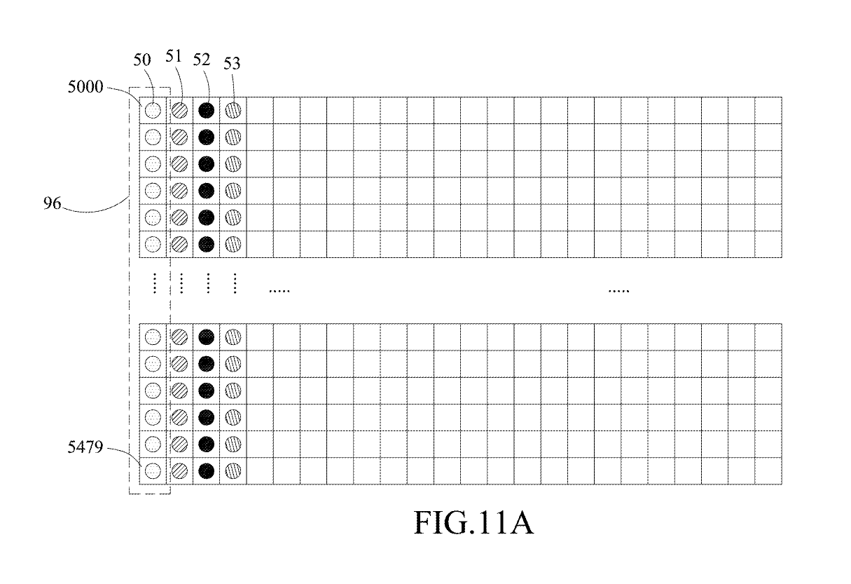

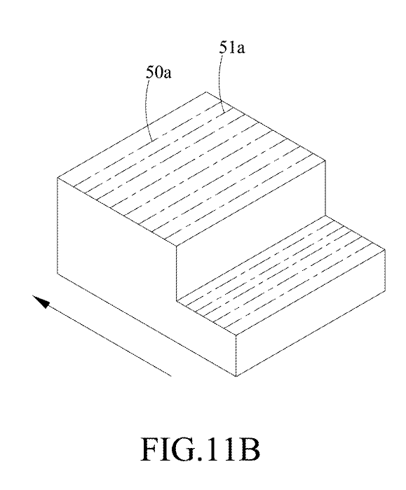

The maximum signal intensity for each interferometric signal of each interferometric image is obtained and then is substituted into the linear function so as to calculate the height value and record the calculated height value into a memory block defined in a memory unit shown in FIG. 11A, which illustrates a record result after calculating the height value with respect to the pixel position having maximum signal intensity, wherein the numerical notation 50 represents memory column recording the height values corresponding to the cross-sectional profile of the object. The memory column has a plurality of memory blocks, each of which records height value corresponding to the maximum signal intensity of each row of interferometric signal acquired along the first direction of the interferometric image, illustrated as FIG. 4C, acquired at the first scanning time. Taking an image having a size of 640 (pixel)×480 (pixel) as an example, in such case, the quantity of memory blocks in memory column 50 is 480, which notated from 5000 to 5479. Likewise, numerical notation 51 to 53 respectively represents the interferometric image acquired from the second scanning time to the fourth scanning time analogously. According to the recording result illustrated in FIG. 11A, the cross-sectional profile of the object corresponding to each scanning time is formed according to height information recorded in each column 96 because, for each column 96, each height value recorded in each memory block represents the maximum signal intensity of the interferometric signal in each row of the interferometric image at a specific scanning time.

Please refer to FIG. 11B, which illustrates the surface profile of the object. By means of combining the height value recorded in the plurality columns shown in FIG. 11A, the three-dimensional surface profile of the object can be formed. For example, memory column 50 represents the cross section 50a shown in FIG. 11B, while memory column 51 represents the cross section 51a shown in FIG. 11B. Analogously, the surface profile of the object can be reconstructed. The foregoing analysis with respect to the interferometric images is performed by the processor 24, which can execute vertical-scanning interferometric (VSI) analysis to process the interferometric images. In addition to the VSI, it is capable of utilizing the method disclosed in the U.S. Pat. No. 6,449,048 for reconstructing the surface profile of the object.

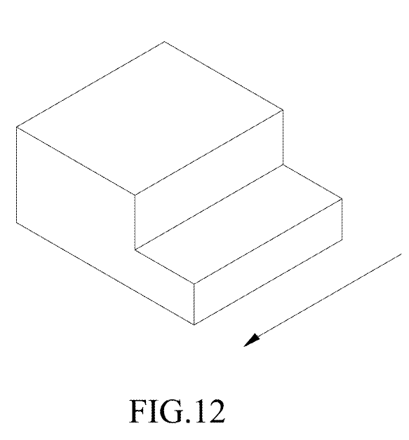

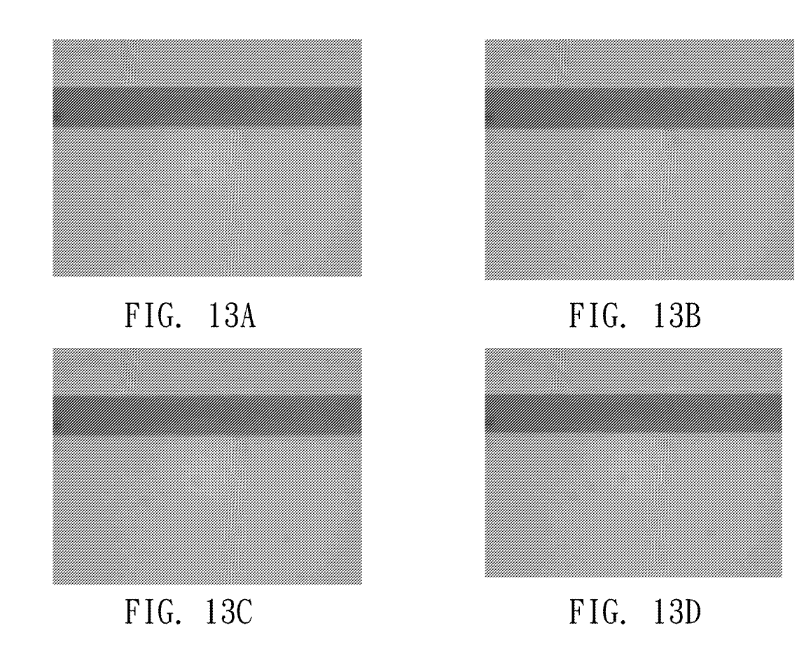

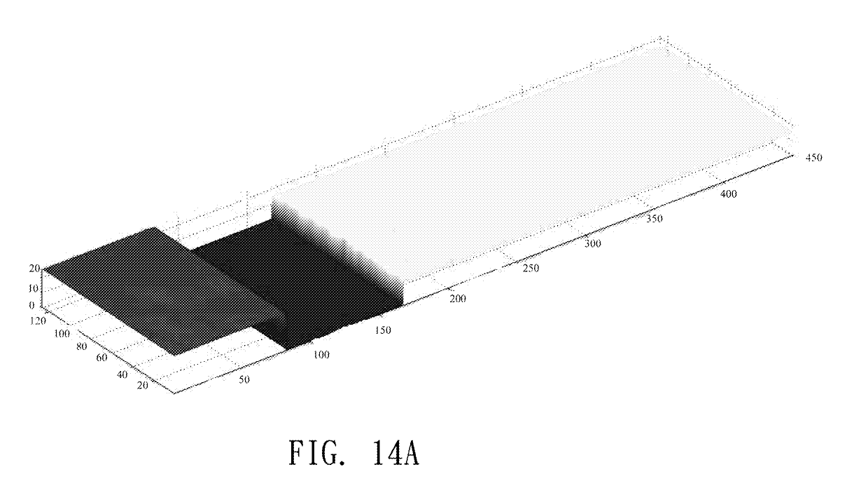

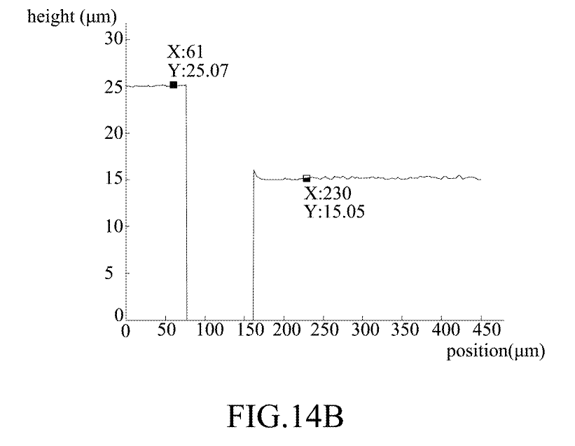

Next, a standard step block illustrated in FIG. 12 is utilized for the interferometry inspection, wherein the step high of the step block is 10.000 nm and the arrow direction shown in FIG. 12 refers to the lateral scanning direction. By means of the interferometric system shown in FIG. 2 or other embodiments disclosed in the present invention, the step block is moved laterally for obtaining a plurality of interferometric images, such as FIG. 13A to FIG. 13D, with respect to a time sequence. After that, the interferometric signal envelope is calculated by the envelope function of white-light interferometry, thereby obtaining the pixel position having the maximum signal intensity. The tilted angle of the reflecting reference element of the modified Michelson interference lens module shown in FIG. 2 is 2.35 degree and the magnification of the objective is 5×. The scanning gap is 1.400 μm while a number of 400 interferometric images are acquired. The reconstructed three-dimensional surface profile of the step block is illustrated in FIG. 14A, while the FIG. 14B is a cross-sectional view about the Y-axis. The calculated maximum inspection error is 0.020 μm, which is only the 0.2% of the overall measured depth range. Although the foregoing inspection is an embodiment for replacing the vertical-scanning interferometry analysis, the one having ordinary skill in the art is capable of applying the present invention in the field of phase-shifting interferometry analysis according to the spirit of the present invention.

With respect to the above description then, it is to be realized that the method and system of lateral scanning interferometry are capable of replacing the conventional vertical-scanning interferometry for obtaining the cross-section profile information so that the time-consuming problem of the vertical-scanning interferometry can be improved, and all equivalent relationships to those illustrated in the drawings and described in the specification are intended to be encompassed by the present disclosure.

What is claimed is:

1. A method for lateral scanning interferometry comprising steps of:
providing a lateral scanning interferometric system comprising a light source for providing an inspection light, an interference lens module having a reflecting reference element and a beam splitter for splitting the inspection light into a first inspection light, being projected onto an object thereby forming an object light, and a second inspection light, being projected onto the reflecting reference element thereby forming a reference light, wherein the reference light further meets and interferes with the object light at the beam splitter so as to form an interfering light, and an image sensing module for acquiring the interfering light;
inclining the reflecting reference element at a tilted angle; and
performing a lateral scanning by the lateral scanning interferometric system and acquiring the interfering light for forming an interferometric image by the image sensing module.

2. The method of claim 1, further comprising a step of calibrating the reflecting reference element for obtaining a height correlation function corresponding to a plurality of sensing elements of the image sensing module.

3. The method of claim 1, wherein the inspection light is a broad-band inspection light.

4. The method of claim 1, further comprising a step of analyzing the interferometric image for obtaining a surface profile with respect to the object.

5. The method of claim 4, wherein the analyzing step further comprising steps of:
obtaining interferometric images respectively corresponding to a specific scanning time during the lateral scanning process;
acquiring a plurality of interferometric signals along a first direction of each interferometric image;
determining a height value according to a maximum signal intensity of each interferometric signal in each interferometric image so as to obtain a plurality of cross-section profile information respectively corresponding to different specific scanning times; and
combining the plurality of cross-section profile information for obtaining the surface profile with respect to the object.

6. The method of claim 5, wherein the steps for determining the height value further comprises the following:
establishing a height correlation function corresponding to a plurality of sensing elements of the image sensing module under the inclining status of the reflecting reference element;
obtaining the position of the sensing element corresponding to the maximum interferometric signal; and
obtaining the height value corresponding to the sensing element according to the height correlation function.

7. The method of claim 4, wherein the analyzing method is a vertical-scanning interferometry analysis.

8. A lateral scanning interferometric system comprising:
a light source for providing an inspection light;
an interference lens module having a reflecting reference element with a tilted angle and a beam splitter for splitting the inspection light into a first inspection light, being projected onto an object thereby forming an object light, and a second inspection light, being projected onto the reflecting reference element thereby forming a reference light, wherein the reference light further meets and interferes with the object light at the beam splitter so as to form an interfering light;
an image sensing module receiving the interfering light for forming an interferometric image; and
a moving stage for supporting the object and performing a lateral movement.

9. The system of claim 8, wherein the reflecting reference element couples to an angle-adjusting unit for controlling the tilted angle.

10. The system of claim 8, wherein the inspection light is a broad-band inspection light.

11. The system of claim 8, further comprising a processor for analyzing the interferometric image so as to reconstruct the surface profile of the object.

12. The system of claim 11, wherein the processor obtains interferometric images respectively corresponding to different specific scanning times during the lateral movement of the moving stage, acquires a plurality of interferometric signals along a first direction of each interferometric image, determines a height value according to a maximum signal intensity among each of the interferometric signal in each interferometric image so as to obtain a plurality of cross-section profile information respectively corresponding to the specific scanning times, and combines the plurality of cross-section profile information for obtaining the surface profile with respect to the object.

13. The system of claim 11, wherein the analyzing method is a vertical-scanning interferometric analysis.

14. A lateral scanning interferometric system comprising:
a light module for providing at least one inspection light;
an interference lens module having at least one reflecting reference element respectively having a tilted angle, at least one micro-objective module, each of which including a plurality of micro-objective lens, each of the micro-objective lens having a focal depth so that the plurality of micro-objective lens forms a continuous interferometric coherent plane having the tilted angle, and at least one beam splitter, each beam splitter splitting the inspection light into a first inspection light being projected onto an object thereby forming an object light and a second inspection light being projected onto the reflecting reference element thereby forming a reference light wherein the reference light further meets and interferes with the object light at the at least one beam splitter so as to form at least one interfering light;
an image sensing module having a plurality of image sensing elements for receiving the at least one interfering light, thereby forming at least one interferometric image; and
a moving stage for supporting the object and performing a lateral movement.

15. The system of claim 14, wherein the reflecting reference element couples to an angle-adjusting unit for controlling the tilted angle.

16. The system of claim 14, wherein the inspection light is a broad-band inspection light.

17. The system of claim 14, further comprising a processor for analyzing the interferometric image so as to reconstruct the surface profile of the object.

18. The system of claim 17, wherein the processor obtains interferometric images respectively corresponding to different specific scanning times during the lateral movement of the moving stage, acquires a plurality of interferometric signals along a first direction of each interferometric image, determines a height value according to a maximum signal intensity among each of the interferometric signal in each interferometric image so as to obtain a plurality of cross-section profile information respectively corresponding to the specific scanning times, and combines the plurality of cross-section profile information for obtaining the surface profile with respect to the object.

19. The system of claim 17, wherein the analyzing method is a vertical-scanning interferometric analysis.

20. The system of claim 14, wherein the micro-objective module is an one-dimensional or a two-dimensional micro objective array.

21. The system of claim 14, wherein the image sensing module is a kind of optical sensing device utilized in a conventional optical microscopic system or in an infinitive-compensation optical microscopic system.
